(19) United States
(12) Patent Application Publication
(10) Pub. No.: US 2008/0114133 A1
(43) Pub. Date: May 15, 2008

(54) Coating compositions

(75) Inventors: Christian Wamprecht, Neuss (DE); Markus Mechtel, Bergisch Gladbach (DE); Thomas Klimmasch, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/983,942

(22) Filed: Nov. 13, 2007

(30) Foreign Application Priority Data
Nov. 15, 2006 (DE) 102006053741.6

(51) Int. Cl. C08G 63/12

(52) U.S. Cl. 525/450

(57) ABSTRACT

The present invention relates to novel compositions of oligocarbonate polyols and oligoester polyols and their use in coating compositions for the production of coatings, particularly scratch-resistant topcoats.

### CROSS-REFERENCE TO RELATED APPLICATIONS

The present application claims the right of priority under 35 U.S.C. § 119 (a)-(d) of German Patent Application Number 10 2006, filed Nov. 15, 2006.

### BACKGROUND OF THE INVENTION

The present invention relates to compositions of oligocarbonate polyols and oligoester polyols and their use in coating compositions for scratch-resistant topcoats.

Scratch-resistant topcoats, particularly for the automotive topcoat sector and for automotive refinishing, have already been of great interest for many years. In addition to low scratching tendency (e.g. in a car wash) these paint systems must also have a marked solvent and acid resistance.

Particularly in recent years, therefore, 2-component (“2K”) polyurethane (“PUR”) systems have become established on the market, distinguished particularly by good resistance to solvents and chemicals with, at the same time, good scratch resistance and excellent weathering resistance.

Polyacrylates, optionally mixed with polyesters, are often used in systems of this type as polyol binders. Aliphatic and/or cycloaliphatic polyisocyanates based on hexamethylene diisocyanate and isophorone diisocyanate are mainly used as crosslinking agents.

These 2-component polyurethane coating compositions have achieved a very good overall property level but, particularly with dark shades, scratching of the clearcoat is often observed after frequent washing in car washes. Depending on the elasticity adjustment of the paint film, the scratches gradually heal by what is known as reflow. However, if the elasticity of the clearcoat film is increased to improve the reflow behavior, the paint loses surface hardness and in particular the solvent and chemical resistance, especially the acid resistance, deteriorates [Carl Hanser Verlag, Munich, MO Metalloberfläche 54 (2000) 60-64]. Thus there have been efforts to improve the scratch resistance of 2-component PUR paints by increasing the elasticity of the polyol component, mainly by compositions of polyacrylates and more elastic polyesters.

DE-A 198 24 118 describes polyester-polyacrylate-based, low-solvent binders which can be cured with di- and/or polyisocyanates to form quick-drying coatings with good adhesion. Owing to the high proportion of polyester, however, these exhibit inadequate acid resistance and are unsuitable for use in automotive topcoats.

WO 96/20968 describes a coating composition for cars and lorries which contains a polyacrylate based on alkyl-substituted cycloaliphatic (meth)acrylate monomers or alkyl-substituted aromatic vinyl monomers, a multihydroxyfunctional oligoester and a polyisocyanate. However, since the oligoesters contain a relatively large number of secondary as well as primary hydroxyl groups as a result of their manufacture, and very large quantities of these esters (>60 wt. % based on the overall formulation) have to be used for low-viscosity coating compositions (<3,000 mPa·s/23° C.), these cure very slowly and at relatively high temperatures, and so they are unsuitable for temperature-sensitive substrates such as plastic add-on parts.

EP-A 0 896 991 describes coating compositions based on polyacrylate-polyester mixtures with polyester proportions of ≦10 wt. % and hydroxyl values of 40 to 125 mg KOH/g. Because of the resulting low crosslink density, PUR paints produced therefrom do not exhibit adequate solvent and chemicals. Furthermore, at 3,000 to 5,000 mPa·s (23° C.) with a solids content of 70 wt. %, the viscosity is too high for the formulation of high-solids PUR paints.

In other publications, such as in EP-A 1 101 780, EP-A 0 819 710 and EP-A 0 778 298, the use of mixtures of polyacrylates with other polyols, such as polyesters and/or polycarbonates, as polyol binders and reactants for polyisocyanate crosslinking agents is often mentioned in general terms without going into the special advantages of precisely these mixtures. Moreover, no information is given on the quantitative composition or the molecular weight and OH functionality of the polycarbonate polyol of these mixed systems.

In the anonymous publication 493099 of Research Disclosure of May 2005, page 584, polycarbonate diols and their possible combinations with other polyols are described, as well as corresponding polyurethane coatings. The properties of paints of this type that can be achieved, such as good adhesion, high gloss, hardness development, flow, alkali resistance, flexibility, elasticity, impact resistance and abrasion resistance, are mentioned generally without any corresponding test results or evidence. No information can be found relating to an improvement in the scratch resistance of paints.

The object of the present invention was, therefore, to provide novel coating compositions which exhibit an improvement in scratch resistance without any negative effect on the acid and solvent resistance of the topcoat systems.

Surprisingly, it has been found that, by using special combinations of oligocarbonate polyols and oligoester polyols in formulations for coating compositions, topcoats can be produced which exhibit markedly improved scratch resistance with equally good or improved solvent and chemical resistance.

### SUMMARY OF THE INVENTION

The present invention therefore provides a binder composition consisting of
A) 5 to 95 wt. % of one or more aliphatic oligocarbonate polyols with a number-average molecular weight Mn of 200 to 5,000 g/mol, and
B) 95 to 5 wt. % of one or more oligoester polyols with a number-average molecular weight Mn of 200 to 5,000 gμmol,
   wherein the quantities of A) and B) add up to 100 wt. %.

### DETAILED DESCRIPTION OF THE PREFERRED EMBODIMENTS

Aliphatic oligocarbonate polyols having a number-average molecular weight of 200 to 3,000 g/mol are preferably used in A), particularly preferably 200 to 2,000 g/mol and especially preferably 300 to 1,500 g/mol.

Aliphatic oligocarbonate polyols of the aforementioned type having an OH functionality of 1.5 to 5 are preferably used in A), particularly preferably 1.7 to 4, especially preferably 1.9 to 3.

The quantity of component A) is preferably 10 to 80 wt. % and A) is particularly preferably used in quantities of 15 to 65 wt. % and A) is especially preferably used in quantities of 20 to 50 wt. %.

The preparation of the aliphatic oligocarbonate polyols used in A) can take place by transesterification of monomeric dialkyl carbonates such as dimethyl carbonate, diethyl carbonate etc. with polyols having an OH functionality ≧2.0, such as 1,4-butanediol, 1,3-butanediol, 1,5-pentanediol, 1,6-hexanediol, 3-methyl-1,5-pentanediol, 1,12-dodecanediol, 1,4-cyclohexanedimethanol, trimethylolpropane, glycerol etc. and is described by way of example in EP 1 404 740 B1, Examples 1 to 5, and EP 1 477 508 A1, Example 3.

For the binder compositions according to the invention, aliphatic oligocarbonate polyols are preferably used and particularly preferably aliphatic oligocarbonate polyols having a molecular weight of 200 to 2,000 g/mol based on 1,4-butanediol, 1,6-hexanediol, 3-methyl-1,5-pentanediol, 1,4-cyclohexanedimethanol, trimethylol-propane, glycerol or mixtures thereof. The molecular weight of the oligocarbonate polyols is especially preferably 300 to 1,500 g/mol.

Oligoester polyols having a number-average molecular weight of 200 to 3,000 g/mol are preferably used in B), particularly preferably 200 to 2,000 g/mol and especially preferably 300 to 1,500 g/mol.

Aliphatic oligoester polyols of the aforementioned type having an OH functionality of 1.5 to 6 are preferably used in B), particularly preferably 2 to 4, especially preferably 2 to 3.

The quantity of component B) is preferably 90 to 20 wt. %, B) is particularly preferably used in quantities of 85 to 35 wt. % and B) is especially preferably used in quantities of 80 to 50 wt. %.

The preparation of the aliphatic oligoester polyols used in B) can take place by reaction of cyclic lactones, such as ε-caprolactone or γ-butyrolactone, with polyols having an OH functionality ≧2.0, such as 1,2-ethanediol, 1,2-propanediol, 1,3-propanediol, diethylene glycol, 1,4-butanediol, 1,3-butanediol, 1,5-pentanediol, 1,6-hexanediol, 3-methyl-1,5-pentanediol, 1,12-dodecanediol, 1,4-cyclohexane-dimethanol, trimethylolpropane, glycerol, pentaerythritol, sorbitol etc. and is described by way of example in EP 1 404 740 B1, Examples 1 to 5, and EP 1 477 508 A1, Example 3.

For the polyol compositions according to the invention, aliphatic oligoester polyols are preferably used and particularly preferably aliphatic oligoester polyols having a molecular weight of 200 to 2,000 g/mol based on 1,4-butanediol, 3-methyl-1,5-pentanediol, 1,6-hexanediol, 1,4-cyclohexanedimethanol, trimethylolpropane, glycerol, pentaerythritol or mixtures thereof.

The polyol compositions according to the invention consisting of the oligocarbonate polyols A) and the oligoester polyols B) can already be used as they are, as binders and reactants for crosslinking resins for the production of coating compositions and paints, especially scratch-resistant topcoats. Preferably, however, the polyol compositions according to the invention are used in combination with polyacrylate polyols C) as an additional polyol component in corresponding coating compositions and paints.

The polyacrylate polyols C) are in particular polymers of alkyl, aryl and/or cycloalkyl esters of acrylic or methacrylic acid with other olefinically unsaturated monomers or oligomers such as e.g. styrene, c-methylstyrene, vinyltoluene, olefins such as e.g. 1-octene and/or 1-decene, vinyl esters such as e.g. VeoVa® 9 and/or VeoVa® 10 from Hexion, (meth)acrylonitrile, (meth)acrylamide, methacrylic acid, acrylic acid, polybutadienes and monomers containing groupings capable of crosslinking reactions such as e.g. hydroxyalkyl esters of acrylic or methacrylic acid, glycidyl esters of acrylic or methacrylic acid and/or aminofunctional esters of acrylic or methacrylic acid.

The OH group-reactive crosslinking resins D) are any polyisocyanates prepared by modifying simple aliphatic, cycloaliphatic, araliphatic and/or aromatic diisocyanates, made up of at least two diisocyanates, with uretdione, isocyanurate, allophanate, biuret, iminooxadiazinedione and/or oxadiazinetrione structure, as described by way of example e.g. in J. Prakt. Chem. 336 (1994) 185-200, the documents DE-A 16 70 666, 19 54 093, 24 14 413, 24 52 532, 26 41 380, 37 00 209, 39 00 053 and 39 28 503 or EP-A 336 205, 339 396 and 798 299.

Suitable diisocyanates for the preparation of these polyisocyanates are any diisocyanates obtainable by phosgenation or by phosgene-free processes, e.g. by thermal urethane cleavage, in the molecular weight range of 140 to 400 g/mol with aliphatically, cycloaliphatically, araliphatically and/or aromatically bonded isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis(isocyanatomethyl)norbornane, 1,3- and 1,4-bis(2-isocyanatoprop-2-yl)benzene (TMDI), 2,4- and 2,6-diisocyanatotoluene (TDI), 2,4′- and 4,4′-diisocyanatodiphenylmethane (MDI), 1,5-diisocyanato-naphthalene or any mixtures of such diisocyanates.

Polyisocyanates or polyisocyanate mixtures of the aforementioned type with exclusively aliphatically and/or cycloaliphatically bonded isocyanate groups are preferred.

Polyisocyanates or polyisocyanate mixtures with an isocyanurate structure based on HDI, IPDI and/or 4,4′-diisocyanatodicyclohexylmethane are especially preferred.

Furthermore, it is also possible to use so-called blocked polyisocyanates and/or isocyanates, preferably blocked polyisocyanates or polyisocyanate mixtures, especially preferably blocked polyisocyanates or polyisocyanate mixtures with an isocyanurate structure based on HDI, IPDI and/or 4,4′-diisocyanatodicyclohexylmethane.

The blocking of (poly)isocyanates for the temporary protection of the isocyanate groups is a working method that has long been known and is described e.g. in Houben Weyl, Methoden der organischen Chemie XIV/2, pp. 61-70.

All compounds that can be eliminated on heating the blocked (poly)isocyanate, optionally in the presence of a catalyst, can be considered as blocking agents. Suitable blocking agents are e.g. sterically demanding amines, such as dicyclohexylamine, diisopropylamine, N-tert.-butyl-N-benzylamine, caprolactam, butanone oxime, imidazoles with the various conceivable substitution patterns, pyrazoles such as 3,5-dimethylpyrazole, triazoles and tetrazoles, and also alcohols such as isopropanol, ethanol, tert.-butanol. In addition, there is also the possibility of blocking the isocyanate group in such a way that, in a further reaction, the blocking agent is not eliminated but the transient formed as an intermediate reacts off. This is particularly the case with cyclopentanone-2-carboxyethyl ester, which reacts completely into the polymer network during the thermal crosslinking reaction and is not eliminated again.

Particularly when blocked polyisocyanates are used, other reactive compounds having groups that are reactive towards OH or NH groups can also be employed as additional crosslinking agent components as well as component D). These are, for example, amino resins.

The condensation products of melamine and formaldehyde or urea and formaldehyde known in paint technology can be regarded as amino resins. All conventional melamine-formaldehyde condensates that are non-etherified or etherified with saturated monoalcohols having 1 to 4 C atoms are suitable. Where other crosslinking agent components are also used, the quantity of binder with NCO-reactive hydroxyl groups must be adapted accordingly.

As catalysts for the reaction of components A) to C) with component D) for the preparation of the coating compositions according to the invention, catalysts such as commercial organometallic compounds of the elements aluminum, tin, zinc, titanium, manganese, iron, bismuth or zirconium can be used, such as dibutyltin laurate, zinc octoate or titanium tetraisopropylate. In addition, however, tertiary amines such as e.g. 1,4-diazabicyclo-[2.2.2]-octane are also suitable.

Moreover, it is possible to accelerate the reaction of component D) with components A) to C) by performing the curing at temperatures of between 20 and 200° C., preferably between 60 and 180° C., particularly preferably between 70 and 150° C.

In addition to the polyol mixture of A) and B), which is essential for the invention, other organic polyhydroxyl compounds or amine-type reactive thinners known to the person skilled in the art from polyurethane paint technology can also be used.

These other polyhydroxyl compounds can be the conventional polyether or polyurethane polyols or other, as yet undescribed, polycarbonate, polyester and polyacrylate polyols. In addition to the polyol compositions of A) and B) according to the invention, the already mentioned polyacrylate polyols C), which are known per se, are preferably used as additional organic polyhydroxyl compounds. The amine-type reactive thinners can be products with blocked amino groups, such as aldimines or ketimines, or those that still contain free amino groups which are, however, of reduced reactivity, such as aspartic esters. These reactive thinners typically have more than one (blocked) amino group, so that they contribute to the construction of the polymeric paint film network during the crosslinking reaction.

Where other polyhydroxyl compounds or amine-type reactive thinners of the aforementioned type are used in addition to the polyol components A) to C), the proportion of these additional compounds that are reactive towards isocyanates is no more than 50 wt. %, preferably no more than 30 wt. %, based on the quantity of components A) to C). Particularly preferably, however, the polyol components A) to C) are used as the sole polyol components in the coating compositions according to the invention.

The ratio of component D) to components A) to C) and optionally other crosslinking agents and hardeners is established here such that an NCO/OH ratio of the free and optionally blocked NCO groups to the isocyanate-reactive groups of 0.3 to 2, preferably 0.4 to 1.5, particularly preferably 0.5 to 1.2, results.

In the coating compositions according to the invention, in addition to components A) to C) and D), auxiliary substances conventional in coating technology, such as inorganic or organic pigments, other organic light stabilizers, radical interceptors, paint additives such as dispersing agents, flow promoters, thickeners, defoamers and other auxiliaries, adhesion promoters, fungicides, bactericides, stabilizers or inhibitors and other catalysts can also be used.

The coating compositions according to the invention are preferably employed in the sectors of automotive OEM coating, automotive refinishing, large vehicle painting, plastics painting, general industrial painting, floor coating and/or wood/furniture painting.

The invention therefore also provides coatings and coated substrates which are obtainable using the polyol compositions of A) and B) according to the invention.

### EXAMPLES

Desmophen® A 870: polyacrylate containing hydroxyl groups from Bayer MaterialScience AG, Leverkusen, DE; approx. 70% in butyl acetate, hydroxyl content according to DIN 53 240/2 approx 2.95%.

Desmophen® VP LS 2971: elasticizing polyester containing hydroxyl groups from Bayer MaterialScience AG, Leverkusen, DE; approx. 80% in butyl acetate, hydroxyl content according to DIN 53 240/2 approx 3.8%.

Desmodur® N 3600: aliphatic polyisocyanurate from Bayer MaterialScience AG, Leverkusen, DE; 100 wt. % with an NCO content according to DIN EN ISO 11909 of 23 wt. %.

Desmodur® N 3390 BA: aliphatic polyisocyanurate from Bayer MaterialScience AG, Leverkusen, DE; 90 wt. % in n-butyl acetate with an NCO content according to DIN EN ISO 11909 of 19.6 wt. %.

The determination of the hydroxyl value (OH value) took place in accordance with DIN 53240-2.

The viscosity determination took place using an “MCR 51” rotary viscometer from Paar, Germany, in accordance with DIN EN ISO 3219.

The determination of the acid value took place in accordance with DIN EN ISO 2114.

The determination of the color value (APHA) took place in accordance with DIN EN 1557.

### Example 1

### Polycarbonate Diol A1

### Preparation of an Aliphatic Oligocarbonate Diol Based on 1,6-hexanediol/1,4-butanediol with a Number-Average Molecular Weight of 2,000 g/mol

1,390 g 1,4-butanediol and 608 g 1,6-hexanediol were initially charged into a 6 l pressurized reactor having a distillation head, stirrer and receiver, with 0.7 g yttrium(III) acetylacetonate and 914 g dimethyl carbonate at 80° C. The reaction mixture was then heated to 150° C. in 2 h under a nitrogen atmosphere and kept at that temperature with stirring under reflux for 2 h, during which time the pressure rose to 3.9 bar (absolute). The cleavage product methanol mixed with dimethyl carbonate was then removed by distillation, the pressure being reduced continuously by a total of 2.2 bar within 4 h. The distillation operation was then ended and a further 914 g of dimethyl carbonate were metered into the reaction mixture at 150° C. and kept at that temperature with stirring under reflux for 2 h, during which time the pressure rose to 3.9 bar (absolute). The cleavage product methanol mixed with dimethyl carbonate was then removed again by distillation, the pressure being reduced continuously by a total of 2.2 bar within 4 h. The distillation operation was then ended and a further 782 g of dimethyl carbonate were metered into the reaction mixture at 150° C. and kept at that temperature with stirring under reflux for 2 h, during which time the pressure rose to 3.5 bar (absolute). The cleavage product methanol mixed with dimethyl carbonate was then removed again by distillation, the pressure being reduced to normal pressure within 4 h. The reaction mixture was then heated to 180° C. within 2 h and kept at this temperature for 2 h with stirring. Following this, the temperature was reduced to 130° C. and a nitrogen stream (5 l/h) was passed through the reaction mixture while the pressure was reduced to 20 mbar. The temperature was then increased to 180° C. within 4 h and kept there for 6 h. During this time, methanol mixed with dimethyl carbonate was further removed from the reaction mixture.

After ventilating and cooling the reaction mixture to room temperature, a colorless, wax-like oligocarbonate diol was obtained with the following characteristic values:

Mₙ=1,968 g/mol; OH value=57 mg KOH/g; viscosity: 3,513 mPa·s at 75° C., Hazen color value: 47 APHA.

### Example 2

### Polycarbonate Diol A2

### Preparation of an Aliphatic Oligocarbonate Diol Based on 3-methyl-1,5-pentanediol with a Number-Average Molecular Weight of 650 g/mol

Procedure as in Example 1, but instead of 1,6-hexanediol, 34,092 g 3-methyl-1,5-pentanediol and 8.0 g ytterbium(III) acetylacetonate were initially charged into a 60 l pressurized reactor and dimethyl carbonate was added in three steps, two each of 10,223 g and one of 7,147 g.

A colorless, liquid oligocarbonate diol was obtained with the following characteristic values: Mₙ=675 g/mol; OH value=166.0 mg KOH/g; viscosity: 4,146 mPa·s at 23° C., Hazen colour value: 17 APHA.

### Example 3

### Polycarbonate Diol A3

### Preparation of an Aliphatic Oligocarbonate Diol Based on Polytetrahydrofuran 250 (Molecular Weight 250 g/mol) with a Number-Average Molecular Weight of 1,000 g/mol

Procedure as in Example 1, but instead of 1,6-hexanediol, 3,259 g polytetrahydrofuran 250 and 0.7 g yttrium(III) acetylacetonate were initially charged into a 6 l pressurized reactor and dimethyl carbonate was added in three steps, two each of 439 g and one of 376 g.

A colorless, liquid oligocarbonate diol was obtained with the following characteristic values: Mₙ=1,002 g/mol; OH value=112 mg KOH/g; viscosity: 1,360 mPa·s at 23° C., Hazen color value: 13 APHA.

### Example 4

### Polycarbonate Diol A4

### Preparation of an Aliphatic Oligocarbonate Diol Based on Cyclohexanedimethanol and 1,4-butanediol with a Number-Average Molecular Weight of 500 g/mol

Procedure as in Example 1, but instead of 1,6-hexanediol, 2,119 g 1,4-cyclohexanedimethanol, 1,325 g 1,4-butanediol and 0.8 g yttrium(III) acetylacetonate were initially charged into a 6 l pressurized reactor and dimethyl carbonate was added in three steps, two each of 1,012 g and one of 867 g.

A colorless, liquid oligocarbonate diol was obtained with the following characteristic values: Mₙ=492 g/mol; OH value=228 mg KOH/g; viscosity: 87,700 mPa·s at 23° C., Hazen color value: 35 APHA.

### Example 5

### Oligoester Polyol B1

### Preparation of an Aliphatic Oligoester Based on Trimethylolpropane

3,155 g trimethylolpropane, 1,345 g ε-caprolactone and 2.25 g dibutyltin dilaurate (DBTL) were weighed into a reactor as in Example 1. The vessel contents were heated to 160° C., stirred at 160° C. for 6 hours and then cooled to 20° C., a clear resin being obtained with the following characteristic data: solids content: 99.5 wt. %, viscosity at 23° C.: 4,100 mPa·s, acid value: 0.5 mg KOH/g, hydroxyl value: 881 mg KOH/g, hydroxyl content: 26.7 wt. %, Hazen color value: 44 APHA.

### Example 6

### Oligoester Polyol B2

### Preparation of an Aliphatic Oligoester Based on Trimethylolpropane

2,747 g trimethylolpropane, 1,753 g ε-caprolactone and 2.25 g dibutyltin dilaurate (DBTL) were weighed into a reactor as in Example 1. The vessel contents were heated to 160° C., stirred at 160° C. for 6 hours and then cooled to 20° C., a clear resin being obtained with the following characteristic data: solids content: 99.5 wt. %, viscosity at 23° C.: 3,300 mPa·s, acid value: 1.0 mg KOH/g, hydroxyl value: 766 mg KOH/g, hydroxyl content: 23.2 wt. %, Hazen color value: 72 APHA.

### Example 7

### Oligoester Polyol B3

### Preparation of an Aliphatic Oligoester Based on Trimethylolpropane

1,977 g trimethylolpropane, 2,523 g 8-caprolactone and 2.25 g dibutyltin dilaurate (DBTL) were weighed into a reactor as in Example 1. The vessel contents were heated to 160° C., stirred at 160° C. for 6 hours and then cooled to 20° C., a clear resin being obtained with the following characteristic data: solids content: 99.6 wt. %, viscosity at 23° C.: 2,080 mPa·s, acid value: 0.6 mg KOH/g, hydroxyl value: 542 mg KOH/g, hydroxyl content: 16.4 wt. %, Hazen color value: 48 APHA.

### Example 8

### Oligoester Polyol B4

### Preparation of an Aliphatic Oligoester Based on Trimethylolpropane

1,407 g trimethylolpropane, 3,593 g ε-caprolactone and 2.25 g dibutyltin dilaurate (DBTL) were weighed into a reactor as in Example 1. The vessel contents were heated to 160° C., stirred at 160° C. for 6 hours and then cooled to 20° C., a clear resin being obtained with the following characteristic data: solids content: 100.0 wt. %, viscosity at 23° C.: 1,730 mPa·s, acid value: 0.5 mg KOH/g, hydroxyl value: 356 mg KOH/g, hydroxyl content: 10.8 wt. %, Hazen color value: 17 APHA.

### Example 9

### Oligoester Polyol B5

### Preparation of an Aliphatic Oligoester Based on Trimethylolpropane

737 g trimethylolpropane, 3,763 g ε-caprolactone and 2.25 g dibutyltin dilaurate (DBTL) were weighed into a reactor as in Example 1. The vessel contents were heated to 160° C., stirred at 160° C. for 6 hours and then cooled to 20° C., a clear resin being obtained with the following characteristic data: solids content: 99.8 wt. %, viscosity at 23° C.: 1,750 mPa·s, acid value: 0.9 mg KOH/g, hydroxyl value: 202 mg KOH/g, hydroxyl content: 6.1 wt. %, Hazen color value: 28 APHA.

### Example 10

### Oligoester Polyol B6

### Preparation of an Aliphatic Oligoester Based on Glycerol

2,010 g glycerol, 2,490 g ε-caprolactone and 2.25 g dibutyltin dilaurate (DBTL) were weighed into a reactor as in example 1. The vessel contents were heated to 160° C., stirred at 160° C. for 6 hours and then cooled to 20° C., a clear resin being obtained with the following characteristic data: solids content: 100.0 wt. %, viscosity at 23° C.: 980 mPa·s, acid value: 1.2 mg KOH/g, hydroxyl value: 811 mg KOH/g, hydroxyl content: 24.6 wt. %, Hazen color value: 23 APHA.

### Examples 11 to 18

### Preparation of the Binder Compositions Consisting of A) and B) According to the Invention

The polycarbonate diols A) and the oligoester polyols B) are stirred for 1 hour at 60° C. in a 1 liter glass flask under a nitrogen atmosphere. The polyol mixtures obtained are then cooled to room temperature, their characteristic data determined and they are held available for the other application examples. The compositions in wt. % solid resin of the polyol components AB1) to AB8) according to the invention are listed in Table 1 and the corresponding characteristic data in Table 2.

TABLE 1
Compositions of the polyol mixtures AB1 to AB8 according to the
invention in wt. %, based on solid resin:

| | Polyol mixture | | | | | | | |
|---|---|---|---|---|---|---|---|---|
| | AB1 | AB2 | AB3 | AB4 | AB5 | AB6 | AB7 | AB8 |
| Component a 1 | 7.7 | — | — | — | — | — | — | 45.5 |
| Component a 2 | — | — | — | 33.3 | — | 25.0 | — | — |
| Component a 3 | — | — | 33.3 | — | 50.0 | — | — | — |
| Component a 4 | — | 66.7 | — | — | — | — | 40.0 | — |
| Component b 1 | — | — | — | 66.7 | — | — | 60.0 | — |
| Component b 2 | — | — | — | — | — | 75.0 | — | — |
| Component b 3 | — | — | — | — | 50.0 | — | — | — |
| Component b 4 | 92.3 | — | — | — | — | — | — | 54.5 |
| Component b 5 | — | — | 66.7 | — | — | — | — | — |
| Component b 6 | — | 33.3 | — | — | — | — | — | — |

TABLE 2
Characteristic data of the polyol mixtures AB1 to AB8 according to
the invention:

| | Polyol mixture | | | | | | | |
|---|---|---|---|---|---|---|---|---|
| | AB1 | AB2 | AB3 | AB4 | AB5 | AB6 | AB7 | AB8 |
| Solids content | 100 | 98.8 | 100 | 99.5 | 100 | 99.7 | 99.2 | 99.6 |
| [wt. %] | | | | | | | | |
| Viscosity at | 2150 | 19700 | 1440 | 4550 | 1830 | 3690 | 10800 | 8140 |
| 23° C. [mPa · s] | | | | | | | | |
| Acid value | 0.5 | 0.4 | 0.4 | 0.2 | 0.3 | 0.4 | 0.2 | 0.1 |
| [mg KOH/g] | | | | | | | | |
| OH value | 328 | 418 | 175 | 656 | 328 | 607 | 595 | 217 |
| [mg KOH/g] | | | | | | | | |
| OH content | 9.9 | 12.7 | 5.3 | 18.8 | 9.9 | 18.4 | 18.0 | 6.6 |
| solid resin [%] | | | | | | | | |

### Examples 19 to 21

### Preparation of Hydroxyfunctional Polyacrylates C) (Not According to the Invention)

These polyacrylate polyols act as combination partners for the polyol compositions AB) according to the invention, consisting of the oligocarbonate polyols A) and the oligopolyester polyols B).

### Preparation Specification for the Copolymers C1 to C3

Part 1 was initially charged into a 5 l stainless steel pressurized reactor with a stirrer, distillation means, receiver vessel for monomer mixture and initiator including metering pumps and automatic temperature regulation, and heated to the desired polymerization temperature. Then, starting at the same time through separate feeds, part 2 (monomer mixture) was metered in over 3 hours and part 3 (initiator solution) over 3.5 hours, the polymerization temperature being kept constant (±2° C.). Stirring was then continued for 60 minutes at the polymerization temperature. The mixture was then cooled to room temperature and the solids content determined. The copolymers should have a solids content of 70±1%. At a solids content of ≦68%, the mixture was post-activated for 30 minutes at 150° C. with 5% of the original quantity of initiator. At a solids content between 68 and 69%, incipient distillation was performed to 70±1%. The copolymer was then filtered (Supra T5500, pore size 25-72 μm Seitz-Filter-Werke GmbH, Bad Kreuznach, DE). The compositions of parts 1 to 3 and the characteristic data of the products are listed in Table 3.

TABLE 3

| | Copolymer | | |
|---|---|---|---|
| | C1 | C2 | C3 |
| Part 1 | | | |
| Butyl acetate | — | — | 25.00 |
| Solvent naphtha 100¹⁾ | 25.00 | 25.00 | — |
| Part 2 | | | |
| Styrene | 10.79 | 11.89 | 27.44 |
| Hydroxyethyl methacrylate | 21.81 | 21.81 | 23.00 |
| Butyl acrylate | 33.51 | 33.51 | 17.04 |
| Polybutadiene Nisso ® B 1000²⁾ | 0.95 | — | — |
| Polybutadiene Lithene AL³⁾ | — | 0.95 | — |
| Acrylic acid | 1.09 | — | 0.68 |
| Part 3 | | | |
| Di-tert.-butyl peroxide | 2.84 | 2.84 | 2.84 |
| Butyl acetate | — | — | 4.00 |
| Solvent naphtha 100¹⁾ | 4.00 | 4.00 | — |
| Polymerization temperature, ° C. | 160 | 160 | 170 |
| Characteristic data | | | |
| Solids content [wt. %] | 70.5 | 69.4 | 70.1 |
| Viscosity at 23° C. [mPa · s] | 3710 | 1140 | 3582 |
| Acid value, as supplied [mg KOH/g] | 10.1 | 1.8 | 7.8 |
| OH value, as supplied [mg KOH/g] | 91 | 93 | 97 |
| OH content, solid resin [wt. %] | 3.9 | 4.1 | 4.2 |
| Hazen color value, as supplied [APHA] | 24 | 19 | 15 |

All quantitative data are to be understood as wt. %.
¹⁾Commercial product from DHC Solvent Chemie GmbH, D-45478 Mulheim an der Ruhr
²⁾Commercial product from Nippon Soda, Japan
³⁾Commercial product from Synthomer GmbH, Frankfurt/Main

### Application Examples

### Example 22

### Preparation of a Base

### Component 22ABC

1.4 g Baysilone® OL 17 (10% solution in MPA; Borchers GmbH, Langenfeld), 2.8 g Tinuvin® 292 (50% solution in MPA, Ciba Spezialitätenchemie Lampertheim GmbH, Lampertheim), 4.2 g Tinuvin® 382/4 (50% solution in MPA, Ciba Spezialitätenchemie Lampertheim GmbH, Lampertheim), 1.4 g Modaflow® (1% solution in MPA; Brenntag AG, Mülheim/Ruhr), 34.8 g of a 1:1 mixture of 1-methoxypropyl acetate-2 and solvent naphtha 100 were added to 120.0 g of a mixture of 36 g polyol AB3 and 84 g polyacrylate polyol C2 and stirred homogeneously.

### Preparation of the Hardener Solution

### Component 22D

23.4 g of a 1:1 mixture of 1-methoxypropyl acetate-2 and solvent naphtha 100 were added to 43.4 g Desmodur® N 3600 and stirred homogeneously.

### Examples 23-25 and Comparative Examples V1 and V2

The same procedure as in example 22. However, the raw materials listed in Table 4 and Table 5 (comparative examples V1 and V2) were used.

TABLE 4

| Base | 23 ABC | | 24 ABC | | 25 ABC | |
|---|---|---|---|---|---|---|
| Polyol AB (quantity used in g) | 60 | g AB4 | 80 | g AB5 | 55 | g AB8 |
| Polyacrylate C (quantity used in g) | 40 | g C2 | 20 | g C3 | 45 | g C1 |
| Total initial weight [g] | 100.0 | | 100.0 | | 100.0 | |
| Baysilone ® OL 17 (10% MPA) [g] | 1.28 | | 1.41 | | 1.29 | |
| Tinuvin ® 292 (50% MPA) [g] | 2.57 | | 2.83 | | 2.58 | |
| Tinuvin ® 382/4 (50% MPA) [g] | 3.85 | | 4.24 | | 3.87 | |
| Modaflow ® (1% MPA) [g] | 1.28 | | 1.41 | | 1.29 | |
| 1-Methoxypropyl acetate-2/solvent naphtha | 42.31 | | 56.47 | | 42.81 | |
| 100 (1:1) [g] | | | | | | |
| Hardener | 23D | | 24D | | 25D | |
| Desmodur ® N 3600 [g] | 122.35 | | — | | — | |
| Desmodur ® N 3390 BA [g] | — | | 101.77 | | 57.65 | |
| 1-Methoxypropyl acetate-2/solvent naphtha | 76.52 | | 45.34 | | 23.78 | |
| 100 (1:1) [g] | | | | | | |

TABLE 5

| Comparative example | V1 | V2 |
|---|---|---|
| Base | | |
| Desmophen ® A 870 [g] | 64.6 | 86.9 |
| Desmophen ® VP LS 2971 [g] | 18.9 | — |
| Baysilone ® OL 17 (10% xylene) [g] | 0.9 | 0.9 |
| Tinuvin ® 292 (10% xylene) [g] | 9.1 | 9.1 |
| Tinuvin ® 1130 (10% xylene) [g] | 18.1 | 18.1 |
| Modaflow ® (1% xylene) [g] | 0.9 | 0.9 |
| 1-Methoxypropyl acetate-2/solvent naphtha 100 (1:1) [g] | 11.9 | 8.7 |
| Butyl glycol acetate [g] | — | 3.6 |
| Hardener | | |
| Desmodur ® N 3390 BA [g] | 33.8 | 33.1 |
| 1-Methoxypropyl acetate-2/solvent naphtha 100 (1:1) [g] | 11.9 | 8.6 |

### Mixing of the Base with the Hardener and Application:

The components ABC (base) and D (hardener) listed above were mixed together in each case and stirred homogeneously. The mixtures were then each applied with an air gun on to coil coating sheets pre-coated with black basecoat, allowed to evaporate for 10 min at room temperature and then stoved for 30 min at 140° C. in a circulating air oven. Sparkling, high-gloss coatings were obtained with a dry film thickness of approx. 40 μm. An overview of the paint properties determined for the coatings is shown in Table 6.

TABLE 6
Paint properties of coatings

| | Example | | | | | |
|---|---|---|---|---|---|---|
| | 22 | 23 | 24 | 25 | Comp. 1 | Comp. 2 |
| Pendulum hardness (s) on glass | 183 | 175 | 169 | 178 | 182 | 197 |
| FAM/XYLENE 10 min | 2/2 | 2/2 | 2/2 | 2/2 | 2/2 | 2/2 |
| Haze | 10 | 9 | 9 | 10 | 11 | 10 |
| Scratch resistance | | | | | | |
| Gloss before (20°) | 88 | 86 | 89 | 88 | 91 | 92 |
| Gloss after 10 cycles (20°) | 78 | 83 | 74 | 80 | 58 | 52 |
| Rel. residual gloss (%) | 89 | 96 | 83 | 91 | 63 | 56 |
| Gloss after 2 h 60° C. reflow | 82 | 84 | 81 | 83 | 75 | 76 |
| Rel. residual gloss after reflow (%) | 93 | 98 | 91 | 94 | 82 | 82 |
| Chemical resistance | | | | | | |
| Tree resin | 36 | 38 | 38 | 38 | 36 | 38 |
| Pancreatin | 36 | 36 | 36 | 36 | 36 | 36 |
| Deionized water | 43 | 46 | 45 | 44 | 40 | 44 |
| NaOH, 1% | 42 | 46 | 44 | 42 | 42 | 42 |
| H₂SO₄, 1% | 43 | 44 | 45 | 43 | 41 | 45 |

### Test Methods:

### Pendulum Hardness:

The pendulum hardness was determined in accordance with DIN EN ISO 1522.

### Resistance to Petrol:

Test with FAM test fuel in accordance with DIN 51 635, based on VDA 621-412 (test A 4.1.1 Y and 4.1.3 Y) and xylene; exposure period 10 min.

### Scratch Resistance:

The scratch resistance was determined in accordance with DIN 55668—method of “Testing the scratch resistance of coatings with a laboratory wash unit”. The degree of gloss was measured as a reflectometer value in accordance with DIN 67 530 before and after stressing by 10 back-and-forth strokes and again after 2 h storage at 60° C. (reflow behavior).

### Chemical Resistance:

The chemical resistance was determined in accordance with DIN EN ISO 2812/5 (draft) in a gradient oven.

The coatings according to the invention as in Examples 22 to 25 exhibit improved scratch resistance—both before and after reflow—as compared with comparative Examples 1 and 2. The chemical resistance of the coatings according to the invention is also better overall than that of the two comparative examples.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A binder composition, consisting of
A) 5 to 95 wt. % aliphatic oligocarbonate polyols with a number-average molecular weight Mₙ of 200 to 5000 g/mol
B) 95 to 5 wt. % oligoester polyols with a number-average molecular weight of 200 to 5000 g/mol,
wherein the quantities of A) and B) add up to 100 wt. %.

2. A binder composition according to claim 1, wherein the quantity of component A) is 20 to 50 wt. % and the quantity of component B) is 80 to 50 wt. %.

3. A binder composition according to claim 1, wherein at least one of the one or more aliphatic oligocarbonate polyols has a molecular weight of 200 to 2000 g/mol and is based on compounds selected from the group consisting of 1,4-butanediol, 1,6-hexanediol, 3-methyl-1,5-pentanediol, 1,4-cyclohexanedimethanol, trimethylolpropane, glycerol and mixtures thereof.

4. A binder composition according to claim 1, wherein at least one of the one or more aliphatic oligoester polyols has a molecular weight of 200 to 2000 g/mol and is based on compounds selected from the group consisting of ε-caprolactone and 1,4-butanediol, 1,6-hexanediol, 3-methyl-1,5-pentanediol, 1,4-cyclohexanedimethanol, trimethylolpropane, glycerol, pentaerythritol and mixtures thereof.

5. A coating composition comprising a binder composition according to claim 1 and a crosslinking agent component.

6. A coating composition according to claim 5, further comprising a polyacrylate polyol component.

7. A coating composition according to claim 5, wherein the crosslinking agent component comprises one or more amino resins.

8. A coating composition according to claim 5, wherein the crosslinking agent component comprises one or more optionally blocked polyisocyanates or polyisocyanate mixtures with an isocyanurate structure based on HDI, IPDI and/or 4,4′-diisocyanatodicyclohexylmethane.

9. A coating composition according to claim 8, wherein the NCO/OH ratio of the free and optionally blocked NCO groups to the isocyanate-reactive groups is 0.5 to 1.2

10. A coating obtained from the coating compositions according to claim 5.

11. A substrate coated with the coating according to claim 10.
